(19) United States
(12) Patent Application Publication
(10) Pub. No.: US 2007/0156564 A1
(43) Pub. Date: Jul. 5, 2007

(54) Tax reporting system and method

(75) Inventors: George R. Humphrey, Bainbridge Island, WA (US); Marjorie Miller, Bainbridge Island, WA (US)

Correspondence Address: KLARQUIST SPARKMAN, LLP, 121 SW SALMON STREET, SUITE 1600, PORTLAND, OR, 97204, US

(73) Assignee: The Miller Group Resource Information Xchange, LLC

(21) Appl. No.: 11/392,101

(22) Filed: Mar. 28, 2006

Related U.S. Application Data
(60) Provisional application No. 60/755,345, filed on Dec. 30, 2005.

(51) Int. Cl. G06Q 40/00

(52) U.S. Cl. 705/36 T

(57) ABSTRACT

Various new and non-obvious apparatus and methods for gathering and reporting tax credits to the IRS are disclosed. In an exemplary embodiment, reporters are chosen in a business. Question sets tailored for the individual reporters are presented to the reporters at periodic intervals. The reporters are expected to answer the questions within a given time. If the answers indicate that a qualifying activity has occurred, then the reporters are asked to input information into a database about the qualifying activity. Based on the nature of the qualifying activity, one or more of the question sets may be modified to periodically ask about this qualifying event. A qualifying event reported by one reporter can modify another reporter's question set. Reporters are also allowed in input information that is not in the question sets. This information can then be used to make further modifications to the question sets. The information in the database, the answers to the question sets, the information input not in the question sets and information about the specific tax credit is used to generate a tax credit report suitable for submittal to the IRS.

### COPYRIGHT AUTHORIZATION

A portion of the disclosure of this patent document contains material which is subject to copyright protection. The copyright owner has no objection to the facsimile reproduction by any one of the patent disclosure, as it appears in the Patent and Trademark Office patent files or records, but otherwise reserves all copyright rights whatsoever.

### BACKGROUND

Much tax regulation requires extensive recordkeeping, auditing, review, and document retention to successfully claim any tax credits that a person or a company may wish to receive. However, some tax credit programs have requirements that are so onerous even if companies do their best to comply, a large portion of the potential credit may be lost.

Such a program is the Research Tax Credit program. The Research Tax Credit program allows a tax credit of up to 20% for qualified research activities, and so can present a sizeable tax savings for many corporations. However, for many of the companies that file for the credit, only about 30% of the amount the company attempted to claim is allowed by the Government after review.

Companies claiming the Research Tax Credit or similar credits must properly substantiate the credit claimed. This requires, at a minimum, detailed technical knowledge of the various research activities the company engages in and a comprehensive understanding of the tax regulations to determine which activities may qualify for the tax credit. A conservative underlying accounting methodology must then be used to produce the necessary tax credit documentation.

In reality, no companies financial records are aligned with the tax code in all areas, at least because the tax code itself has inconsistencies and conflicting information collecting requirements. Therefore, systems already in place are almost certainly insufficient for new tax credit opportunities.

For a company to qualify for a credit, a qualifying activity must occur. Then, financial information associated with the qualifying activity must be gathered. Financial information is trailing information which often doesn't appear in classic business record form. Expenses associated with the activity may not appear for months or even until the next tax year. These expenditures must be attached to the activity, and then gathered for as long as the tax credit can be taken on them, a time that might be much longer or shorter than is obvious. Once the expenditures are gathered then they must be appropriately handled to meet the requirements of the tax code.

One of the main problems why people are unable to claim the full credit is that some of the information the IRS wants is difficult to capture using standard accounting methods, and some information may simply be unavailable. For example, it is common for tax credits to require accurate records detailing the length of time each person in a team spent working on a project as well as accurate information on salary to determine the exact amount available for the credit. However, supervisory personnel at a company may not have their time on any given day broken down by task. Furthermore, it could be the case that only taxable wages are eligible for the credit. Therefore, bonuses paid to managers may not be eligible, neither may other perks such as expenses relating to company cars. The work required to accurately calculate such a tax after the fact can be astonishing.

As another difficulty, due to the onerous and byzantine reporting requirements, companies rarely receive the entire amount that they claim as a credit. This creates two difficulties. First, they lose the money that they would otherwise have if the full credit could be gained, and second, it creates an error on their financial records. The tax credit was claimed for a specific year, but the IRS does not audit the credit in the year claimed. If the full credit is not allowed, then, through no fault of the company, the financial data for the year in question is incorrect. This may also create ramifications with the Sarbanes Oxley regulations that require that corporations make sweeping disclosures, and that officers of a corporation can receive criminal charges for failing to comply.

### SUMMARY

As described herein, a way for a business to report a tax credit is provided. The various techniques and tools can be used in combination or independently. The disclosed exemplary apparatus and methods should not be construed as limiting in any way. Instead, the present disclosure is directed toward novel and non-obvious features and aspects of the various disclosed embodiments, alone and in various combinations and subcombinations with one another. The methods are not limited to any specific aspect, feature, or combinations thereof, nor do the disclosed methods require that any one or more specific advantages be present or problems be solved.

In one implementation, a system for establishing a tax credit amount for a business is provided. It comprises an in-house computing system associated with the business; at least one satellite computing system; at least two question sets designed to elicit information about possible tax credits; a question set deliverer which delivers the question sets to at least one person at the business at a predetermined interval; and a question set reporting unit which delivers answered question sets to the satellite computing system. The system also comprises a new question transformer which uses the answered question sets to generate at least one new question incorporated into at least one question set to produce a transformed question set; a tax credit calculator which calculates a tax credit based at least in part on the answered question sets and at least one answered transformed question set; and a tax credit reporter which produces a tax credit report to be sent to the Internal Revenue Service based on the calculated tax credit, the answered question sets and the answered transformed question set.

In another embodiment, a method is provided whereby a series of reporters at a business are chosen. These reporters are then given, at designated periods, a set of questions to answer. If the answers to the questions include information indicating that an activity that may qualify for the tax credit is found, then a series of questions relating to that taxable event are asked the reporter. Questions about the taxable event may be asked of different reporters, as well.

At least one reporter will be required to input information into a database associated with the taxable event. The question set given to the reporters is then modified to include questions relating to the taxable event. These questions include information designed to determine if the taxable event is continuing, has stopped temporarily, has permanently stopped, etc. The information put into the database includes technical information, engineering information, scientific information, financial information, and so on. Reporters are also allowed to input information into the database that is not associated with any question. This information may then be used to modify the original question set.

Additional features and advantages will be made apparent from the following detailed description of various embodiments that proceeds with reference to the accompanying drawings.

### BRIEF DESCRIPTION OF THE DRAWINGS

FIG. 1 is a block diagram of an exemplary computer system which can be used to implement tax reporting systems as described herein.

FIG. 2A is a flowchart illustrating an exemplary method for reporting taxes.

FIG. 2B is a continuation of the flowchart detailed in FIG. 2A.

FIG. 3 is a block diagram of a computer system that can be used to implement a tax reporting system

### DETAILED DESCRIPTION OF THE INVENTION

### Overview

At least a portion of the illustrated embodiments help systematize gathering data and reporting on tax credits. The illustrated embodiments also provide records to give to a revenue service to justify a tax credit. Using this system can give more certainty to a company that the credits will be received and can also give more certainty that a larger percentage of the activities that qualify for Tax Credit are captured.

In at least some embodiments, the system is interactive, and learns from the data that it receives. For example, different qualifying activities have the potential for having different qualified costs and different reporting requirements. The system is configured to align with what specific people are doing within various activities.

People in the company who are in position to gather information about qualifying activities are called reporters. At certain intervals, each reporter fills out a question set which, in an illustrative embodiment, is tailored to the specific activity or activities that the reporter does in the company. Questions about qualifying activities may include such information such as “what product is being made” as well as “how is the product being made,” and so forth. As the reporter answers the questions, the underlying software determines what qualifying activities may be occurring. Each reporter may have documents, emails, spreadsheet files, instant messages, quotes, bids, and personnel time information. All of this can potentially be placed in the database. The questions themselves will prompt for the specific information needed. Some information, such as payroll information of a certain type, may not be readily available, and may require that records be kept using a different format. For example, a class of supervisor may be required to keep daily track of the amount of time spent on a project eligible for a tax credit. If the reporter is told of the requirement early on in the taxable event process such information can more easily be gathered. Contemporaneous information that comprises questions that reporters themselves generate that are not part of the standard set can also be attached.

To claim a tax credit, the entity must engage in the behavior that the tax credit is rewarding. For example, with the Research tax credit, companies must at least do one or more of the following: create a new product, develop process changes, implement new manufacturing methods, write or modify software for internal use, and so on. Though these activities often arise in an expected section of the company, such as Research and Development, they also can arise in unexpected parts of the company. These credit-triggering activities are captured, preferably, in the expected and unexpected locations in a company as they occur.

If a qualifying activity is occurring, then the reporter is asked questions from a question set designed for that qualifying activity. If a qualifying activity has occurred in the past, the reporter can be asked about ongoing costs associated with that activity, and can be asked to fill out appropriate reports. Questions can also be asked to determine if an ongoing activity has changed scope, or no longer qualifies. Specific information, such as invoices, emails, instant messages, bids, quotes, proposals, and so forth, can be requested by the system, and can be cataloged when received. If certain information has been requested but not yet received, the missing items can be prompted for. If certain information is not received within a specified time frame, a person other than the reporter, such as a supervisor, can be notified and informed that the needed information is missing.

Furthermore, if the question sets are missing information which would be useful for a particular reporter, or for a particular section of the company, those questions can be added to the question set. The questions can be added by the reporter, by another entity, or the system can learn that certain questions are needed for this specific area and can add them automatically.

This allows, among other features, for information to be generated and stored which is not relevant to the technology or from the point of view of an individual reporter, but which may be required to receive the tax credit. By so doing, a paper trail is created that authenticates the credits. The set of questions asked, and the answers expected are not expected to particularly make sense any given person. In fact, aspects might even be counter-intuitive.

For example, it may be that the tax credit is not allowed for training employees on new technology, but is available for problems ill-trained employees create using the new technology.

Once information is entered into the system it cannot be altered, allowing for a secure audit trail. However, as new information is discovered, it can be added to the database. The data can be viewed historically, that is everything that was known up to a certain date, cumulatively, and so forth.

At certain times, such as when a sufficient amount of information is in the system, or at set intervals or specific dates, reports can be generated automatically or manually.

The system can be tailored to work with different accounting practices. Furthermore, different activities within an organization may be calculated using different accounting practices. The system can accommodate these differences.

As an example, some organizations use a cost center approach which calculates the percentage of qualifying activities out of all activities. Then the amount that can be calculated for the tax credit is that percentage of all costs. For example if a company spent ten million dollars overall, and 20% of the total activities were qualifying then the company would have two million dollars of qualified expense for the tax credit. Other accounting methods such as Unit Cost and Direct Expenditure can also easily be implemented.

The format of the information within the database is in some format or formats held within the database. Once information is in the database, it is interpreted based on appropriate portions of the IRS code which changes the financial information into the types of numbers that need to be part of the credit. When a report is generated, the previously input information that is required to document the credit is, at least partially automatically, attached.

Some events needed to interpret the data and produce IRS ready reports need to be triggered by a human, but some can be automated over time, as the database gets experience. Initially, there is a body of technical knowledge that must be input into the computer by a human. Examples include new changes to the tax law, and specific instances of fitting a given body of tax law to individual and unique entity information. However, once the system learns about a specific entity, the system will be able to build information using the data without human input. The unique data report question sets over time become tailored more specifically to certain activities in the entity that is using them. Pattern recognition, inductive logic programming, neural networks, or some other form of learning algorithm known in the art, for example, can be used to perform the automatic learning tasks.

The IRS or a similar entity can review the information and reports for an entity remotely without site visits to the taxpayer.

One method of communicating between the system and a corporation, company, or entity is to use a secure WWW site as the portal to the system and the system database. In such a system, every reporter receives a user name and password. This gives each reporter secure access to the site and only allows them to interact with their portion of it.

The described embodiments provide combinations of functional elements to document, calculate and preserve Research Tax Credit benefits with remote access for data input, data translation and segregation, interactive determination of qualifying characteristics by the taxpayer and remote audit and review by Internal Revenue Service.

To claim a tax credit, the entity must engage in the behavior that the tax credit is rewarding. For example, with the Research tax credit, companies must at least create a new product, develop process changes, implement new manufacturing methods, write or modify software for internal use, and so on. Rather than focusing on an expected section of the company, such as the R&D department, such activities can come from a wide range of locations. These credit-triggering activities are captured where ever they occur.

Once the tax entity must engage in “qualifying activities that trigger deductions.” Using the Research Tax credit example, such qualifying activities may be at least one of, entering into fixed- or variable-price contracts, efforts involved in creating proposals and bids, independent research and development efforts. The illustrated embodiments allow capturing these qualifying activities as they occur, and then including them in the eventual tax credit request. When such a qualifying activity occurs, specific information must be recorded, specific records must be kept, and so forth, depending upon the particular qualifying activity. When an activity deemed qualifying occurs, then the system automatically expects the necessary information, and requests such from the appropriate people in the organization as necessary. For example, the IRS can ask to examine contract types, contract stages, costs involved in creating bids and proposals, as well as the costs associated with research undertaken by the entity, and funding received. Significantly all of this information is captured, if possible, as such events occur.

Another area where significant paperwork is captured to glean the allowable tax credit is to continue gathering data after an event which may be disqualifying. For example, the Research Tax Credit in 2005 is not allowed after commercial production, adaptation, or duplication. However, in some cases, such after-commercialization activities still qualify. Furthermore, there is always a chance that a regulation will change, and will be retroactive. By continuing to gather such data, a company can quickly adapt to the changing regulatory world.

Certain provisions of new accounting requirements, such as the Sarbanes-Oxley Act impose draconian recordkeeping and auditing requirements on companies, and officers of such companies.

The software allows creation of unique question sets established for each reporting point to assure the adequacy of information for Research Credit qualification. These questions sets include generically structured formats that can be cloned and/or edited by the software. Question sets for reports are assigned to specific financial entities and to reporting points within those entities.

In some instance, contingency fees may be charged for implementing the Research Tax Credit system at a specific site or sites.

Financial reporting points are assigned to specific financial entities. Standard, periodic financial reports using a financial entity's existing account codes and accounting software are posted and converted to common formats for analysis and future review.

Consolidation reports are created off-line and posted to at least one user-defined data base for each financial entity.

Information in the data base includes multiple separate types and sources. For example, the following is a sample, though by no means a complete list of the types of information that may be input:

1. Non-financial activity information including technical, engineering and scientific information. (The information is at least contemporaneous and/or sequentially periodic.) This information can be in pre-established report forms, but also includes information from the unique question sets.

2. Financial information (periodic and trailing the activity data) from conventional accounting data.

3. Tax specialty information. This information includes time-sensitive contemporaneous analysis of tax credit qualifying information, which ties separately to the non-financial activity information and financial information (this is an important distinction).

4. Consolidation reports created by the software or developed off-line.

5. Information from additional site functions is also maintained in the database.

All data is preferably maintained in a highly secure data base allowing later review of qualified and nonqualified information.

The Internal Revenue Service has approved this technology in a formal Research Credit Recordkeeping Agreement. This technology is a complete departure from past manual documentation and calculation of Research Credits and allows IRS review to occur remotely without site visit's to the taxpayer and eliminates invasive on site review procedures. This efficiency represents significant cost savings for the taxpayer and Internal Revenue Service.

### Exemplary System Embodiment

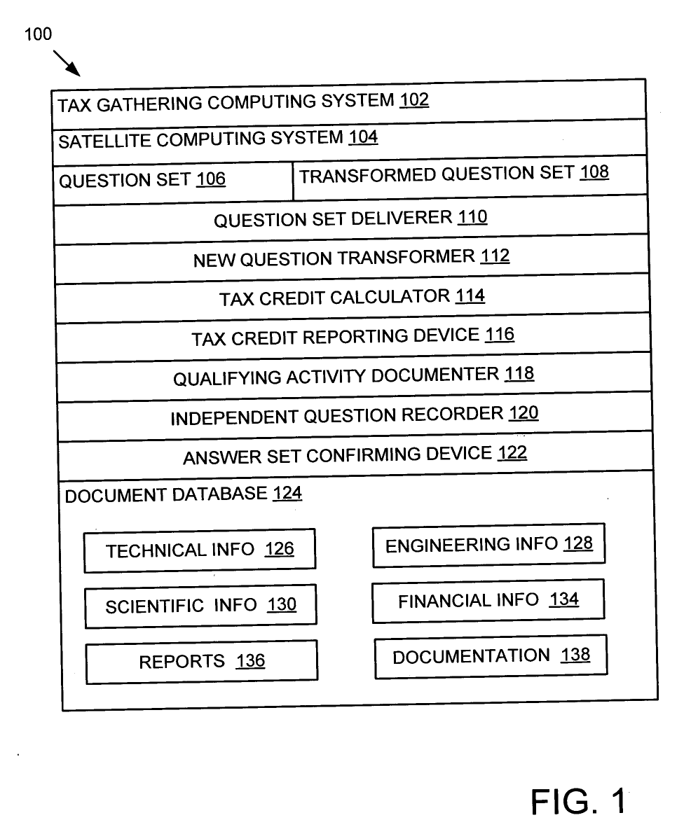

FIG. 1 illustrates a exemplary embodiment of a system 100 that can be used to implement tax reporting system embodiments as described herein. The system 100 has at least one tax information gathering computing system which, in some instances, is an in-house computing system used by a business which wishes to claim a tax credit. This system may be one computer system or may be a series of computer systems at different locations. For example, a very large company may have research and development facilities at two separate sites, and centralized accounting at a third site. Each of these sites may have their own computing systems tied together by a formal or an informal network. Each of these separate computer systems, all of which need to be used to properly identify a tax credit, should be considered the in-house computing system. If a research project is done with a partner company, so that some of the taxable events that need to be documented occur at an entirely different company, then this partner computer system should also be considered part of the same tax gathering computer system.

Some implementations also optionally include a satellite computing system 104. If included, this is a computing system used by a separate business to calculate the resulting tax credit. If included, there are numerous ways that information can be divvied up between the tax-gathering computing system and the satellite system. If two systems are included, then at least some people who generally work on the tax-gathering computer system 102 will also be granted access to the satellite computing system using a password system. Some implementations have only the satellite computing system.

The system also comprises at least one question set. A question set can be general or specific—it can be designed for a specific company, a specific class of company, (such as heavy manufacturer, pharmaceutical, etc,) for a specific position in a company (R&D manager) for a specific position in a specific company (R&D manager at company X) or different criteria can be used. Preferably, several people at a given company are determined to be reporters—those who report on potential taxable events. A periodic time is also determined, which might be the same for all reporters, or which might be different, in that some reporters may need to report on activities every two weeks, for example, while other reporters may only need to report every month. The periodic time may be determined beforehand, may be determined based on events reported by the reporters, may be based on tax regulations, etc. When a reporting time occurs, each appropriate reporter is given a question set by a question set deliverer 110. Each reporter may get a specific question set, or different reporters may be given the same question set, depending on circumstances.

When a reporter answers a question set, the answers are placed in a database 124. The answers to the database can then be examined, either by a person, or using machine learning algorithms known in the art, and questions not on the current question list can then be created using a new question transformer 112.

If the answers given to the question set indicate that an activity qualifying for the tax credit has occurred, then the qualifying activity documenter 118 requests the appropriate documentation necessary to properly substantiate the activity for purposes of the specific tax credit desired. Many different types of information may be requested, including technical information, scientific information, engineering information, financial information, and so on. Sometimes the information asked for (such as specific types of personnel activity records) may not yet exist, and will need to be created by the company. With the recognition that all information may not be readily available, many instantiations include timers, that is, a reporter will be given a specific time to input a specific piece of data. With the recognition that some items may less readily available than others, this time may be fairly lengthy for some information and quite short for information that the reporter would be expected to have. If the requested information is not input by a given time, then the reporter may be again reminded of the need for the information, the reporter's supervisor may be notified that the requested information has not been input, and so on.

Similarly, the reporter is expected to answer each question truthfully in the question set. This can be reinforced by the answer set confirming device 122 which can be set to require the reporter to sign off on the question set, in some embodiments. In other embodiments, other people in the business may also be required to sign off on the question set, as well, by the answer set confirming device 122. Signing off may be as minor as stating that all questions have been read, or as major as vouching for the answers.

All possible situations will probably not be covered by the question sets initially give to the reporters. To handle this problem, the independent question recorder 120 allows the reporters input questions, answers, or comments about issues that appear important but that have not been addressed by the current question sets 104. This independent information, as well as the answers previously given to the question sets, and other information, can be used by the new question set transformer 112 to create new questions which can then be added to at least one question set 104, creating a transformed question set 106. This process can be recursive, with the answers to the transformed question set generating new questions which then produce an updated transformed question set, and so on.

At specific times, the information in the database 124 is used by the tax credit calculator 113 to calculate the potential tax credit. Specific IRS regulations are also used. Other information may be required as well. This calculation may be done automatically, or may require human intervention at certain steps. The specific times the tax credit calculator 114 runs may be those times required by the Government, times set by the business to run internal reports, and so forth.

The tax credit reporter 116 works in tandem with the tax credit calculator 114 to produce a report that is in a format suitable to send to the IRS. It may include copies of at least some of the documentation stored in the database, and may include an easy way for the IRS to look at the information reported by the independent question reporter 120, which may highlight unusual events that the IRS may find of high interest. The tax credit reporter may also be set up in such a way that the IRS can examine all of the supporting documentation behind the tax credit without a separate trip to the business at hand.

### Exemplary Method for Calculating a Tax Credit

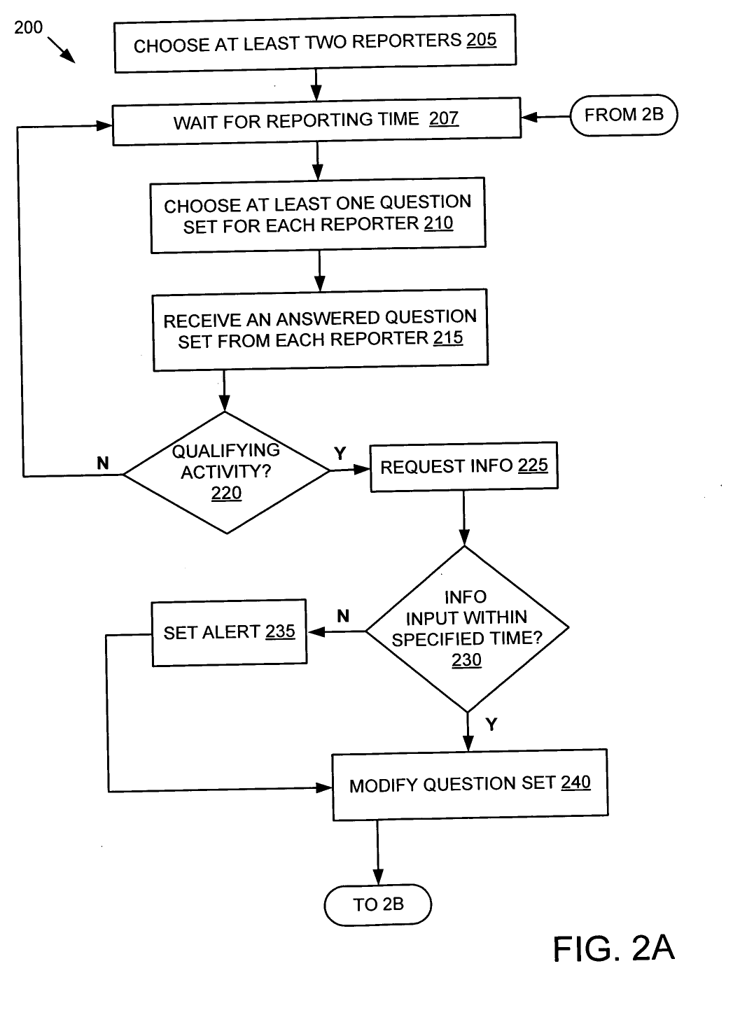

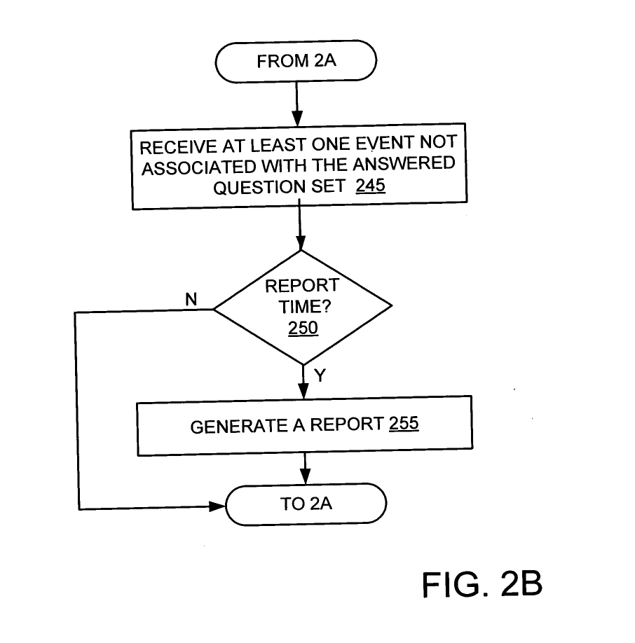

FIG. 2A is a flowchart 200 of a basic procedure for implementing a disclosed embodiment of calculating a tax credit. The flowchart 200 shows only one exemplary embodiment and should not be construed as limiting in any way. With reference to the flowchart of FIG. 2A, at process block 205, at least two reporters are chosen at a business whose tax credit is to be calculated. These reporters may be people in the business who are expected to have access to data which it is necessary to capture to receive a tax credit. Exactly who a company should be considered a reporter, and how many reporters there should be depends on the specific configuration of each company, for the most part. At some companies, the people doing the research themselves may be among the reporters, at other companies, the reporting task may be more practically be done by one or more people in accounting, at yet other companies, the reporting tasks may be spread over a wide range of individuals from research and development, accounting, human resources, training, and so on.

At process block 207, the process waits for a reporting time. Each reporter may have a separate reporting time, depending on the nature of their reporting tasks, or all reporters may report at a designated time, such as the first of every month.

At process block 210 at least one question set is chosen for each reporter. The specifics about what make a good question set for a given reporter are very tax credit specific and task-specific, in that the questions should preferably cover areas that each reporter is familiar with; but, at the same time, all information that must be elicited must also be included in some reporter's set of questions. Therefore, small companies might have just a few reporters with large question sets, while larger companies may divvy up the information among a larger number of reporters. Furthermore, a company may have many people who might be aware of potential tax-credit generating activity. A strategy for such a company may be that a wide variety of people are given similar question sets to ensure complete coverage.

The question sets may include questions of various types, including those that can be answered by yes/no, those that can be answered by selecting from a series of predefined answers, those that require a numerical answer, those that require an individual narrative to answer, and so on. Reporters, in some instances, are allowed to reorder the questions in their question sets.

In some implementations, the question sets include messages that must also be read. Each message may come with a method of verifying that the message has been read. These messages may come from an administrator within the business, from an administrator outside the business who is overseeing or otherwise managing the tax credit process, from a supervisor of the reporter, from a fellow reporter, and so on. Messages may be divided up into those that are required to be read and those that are not required to be read, by the person that send them, and so on. Required messages may automatically display each time the reporter logs into the reporting system or navigates to the message page until the message is read, and the reporter acknowledges the message. The process continues at process block 215.

At process block 215, an answered question set is received from each reporter. This process block may involve the reporters signing off on their answered question sets such that they vouch for the accuracy of the answers.

At decision block 220, it is determined if an activity qualifying for a tax credit has occurred. This is done, for the most part, by examining the answers to the question sets submitted at process block 215. Such activities may be entering into fixed- or variable-price contracts, beginning the process of creating a proposal or a bid, research and development activities, and so on. The determining may be done automatically, may be done by people with knowledge of the tax credit examining the answers, or may be done by a combination of the two. If a qualifying activity is found, then the process continues at process block 225. If a qualifying activity is not found, then the process returns to process block 207.

At process block 225, information about the qualifying activity is requested. Depending on the nature of the qualifying activity, this could be information relating to contracts, bids, proposals, research costs, personnel costs, funding received, and so forth. This information is preferentially gathered as it occurs and stored in a database, the database in a preferred embodiment being secure and accessible only by designated people.

At decision block 230, it is checked if the information requested at process block 225 has been input. If it has been, the process continues at process block 240. If not, at process block 235, an alarm is set. This alarm may be as simple as putting a note in the reporter's next question set again requesting the information, or may involve notifying the reporters superior, etc. In some embodiments, some information will not immediately be available to certain reporters, such that they can input information required by a specific question set over a period of time, such that when a reporter submits an incomplete question set, the next question set for the reporter requests the missing information. The process continues at process block 240.

At process block 240, the answers received at process block 215 and/or the information requested at process block 225 is examined (either automatically, with human oversight, or with some combination of the two) and if necessary, one or more reporter's question sets may be modified.

Reporters may need help answering the questions. To make this process as painless as possible, a database consisting of frequently asked questions (FAQ's) is preferentially provided. These FAQ's are easy to find, and at least some embodiments, the FAQ's are searchable either by category or keyword. With reference to FIG. 2B, rarely will all questions be anticipated, and so reporters, at process block 245, are allowed to input unanticipated questions. These unanticipated questions are then preferentially answered, and the answers may be added to the list of available FAQs. These questions about unanticipated events tend to indicate that something unusual has occurred, and so, in some implementations, events associated with these questions are flagged such that the IRS or another reporting entity can easily find the events and the associated paperwork.

At decision block 250 it is determined if it is time to generate a report. If so, the process continues at process block 255. If not the process continues at decision block 207 (FIG. 2A). This report may be generated when asked, at periodic time, such as at the first and fifteenth of each month, or on a schedule requested by an outside agency.

At process block 255, a report is generated. The report preferably is generated in a format such that it can be submitted to a government agency without further changes. Furthermore, the documents stored in the database should be sufficient to send the report in with all or most of the necessary documentation.

### Computing Environment

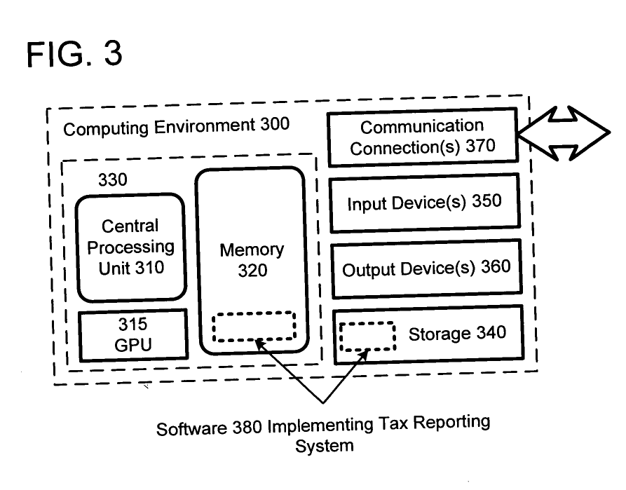

FIG. 3 and the following discussion are intended to provide a brief, general description of an exemplary computing environment in which the disclosed technology may be implemented. For instance, any of the functionalities described with respect to compiling a source code representation in FIG. 3 can be implemented in such a computing environment. Although not required, the disclosed technology was described in the general context of computer-executable instructions, such as program modules, being executed by a personal computer (PC). Generally, program modules include routines, programs, objects, components, data structures, etc., that perform particular tasks or implement particular abstract data types. Moreover, the disclosed technology may be implemented with other computer system configurations, including hand-held devices, multiprocessor systems, microprocessor-based or programmable consumer electronics, network PCs, minicomputers, mainframe computers, and the like. The disclosed technology may also be practiced in distributed computing environments where tasks are performed by remote processing devices that are linked through a communications network. In a distributed computing environment, program modules may be located in both local and remote memory storage devices.

FIG. 3 illustrates a generalized example of a suitable computing environment 300 in which described embodiments may be implemented. The computing environment 300 is not intended to suggest any limitation as to scope of use or functionality of the invention, as the present invention may be implemented in diverse general-purpose or special-purpose computing environments.

With reference to FIG. 3, the computing environment 300 includes at least one central processing unit 310 and memory 320. In FIG. 3, this most basic configuration 330 is included within a dashed line. The central processing unit 310 executes computer-executable instructions and may be a real or a virtual processor. The environment 300 further includes the graphics processing unit GPU at 315 for executing such computer graphics operations as vertex mapping, pixel processing, rendering, and texture mapping. In a multi-processing system, multiple processing units execute computer-executable instructions to increase processing power and as such the GPU and CPU can be running simultaneously. The memory 320 may be volatile memory (e.g., registers, cache, RAM), non-volatile memory (e.g., ROM, EEPROM, flash memory, etc.), or some combination of the two. The memory 320 stores software 380 implementing the described methods of generating typed intermediate language, and of type-checking the generated intermediate language.

A computing environment may have additional features. For example, the computing environment 300 includes storage 340, one or more input devices 350, one or more output devices 360, and one or more communication connections 370. An interconnection mechanism (not shown) such as a bus, controller, or network interconnects the components of the computing environment 300. Typically, operating system software (not shown) provides an operating environment for other software executing in the computing environment 300, and coordinates activities of the components of the computing environment 300.

The storage 340 may be removable or non-removable, and includes magnetic disks, magnetic tapes or cassettes, CD-ROMs, CD-RWs, DVDs, or any other medium which can be used to store information and which can be accessed within the computing environment 300. The storage 340 stores instructions for the software 380 to implement methods of gathering and reporting tax credits.

The input device(s) 350 may be a touch input device such as a keyboard, mouse, pen, or trackball, a voice input device, a scanning device, touchscreen, or another device that provides input to the computing environment 300. For audio, the input device(s) 350 may be a sound card or similar device that accepts audio input in analog or digital form, or a CD-ROM reader that provides audio samples to the computing environment. The output device(s) 360 may be a display, printer, speaker, CD-writer, or another device that provides output from the computing environment 300.

The communication connection(s) 370 enable communication over a communication medium to another computing entity. The communication medium conveys information such as computer-executable instructions, compressed graphics information, or other data in a modulated data signal. These connections may include network connections, which may be wireless connections, may include dial-up connections, and so on. The other computing entity may be a portable communications device such as a wireless handheld device, a cell phone device, and so on.

Computer-readable media are any available tangible media that can be accessed within a computing environment. By way of example, and not limitation, with the computing environment 300, computer-readable media include memory 320, storage 340, communication media, and combinations of any of the above.

In view of the many possible embodiments to which the principles of the disclosed invention may be applied, it should be recognized that the illustrated embodiments are only preferred examples of the invention and should not be taken as limiting the scope of the invention. For example, the system was described with reference to a specific tax credit system, the Research Tax Credit, but it should be understood that the system and methods described herein refer to an apply equally well to any tax credit or reporting system, such as, for example, the reports required by the Sarbanes-Oxley Act. Rather, the scope of the invention is defined by the following claims. We therefore claim as our invention all that comes within the scope and spirit of these claims.

We claim:

1. A computing system for establishing a tax credit amount for a business, comprising:
at least two question sets designed to elicit information about possible tax credits;
a question set deliverer which delivers the question sets to at least one person at the business at a predetermined interval;
a database which stores answered question sets;
a new question transformer which uses the answered question sets to generate at least one new question incorporated into at least one question set to produce a transformed question set;
a tax credit calculator which calculates a tax credit based at least in part on the answered question sets and at least one answered transformed question set; and
a tax credit reporter which produces a tax credit report to be sent to the Internal Revenue Service based on the calculated tax credit, the answered question sets and the answered transformed question set.

2. The system of claim 1, further comprising at least one satellite computing system and wherein the database, tax credit calculator and tax credit reporter are stored at the satellite computing system.

3. The system of claim 1, wherein the tax credit reporter generates a report which conforms to IRS reporting requirements.

4. The system of claim 1, wherein the at least two question sets includes questions to determine if a qualifying activity has occurred and further comprising a qualifying activity documenter which requires that documents associated with the qualifying activity be input into the database.

5. The system of claim 1, further comprising an independent question recorder which allows reporters at the business to input questions not in the question sets, the questions associated with unanticipated events.

6. The system of claim 1, further comprising an answer set confirming device which requires that at least a reporter designated to answer the question set confirm that the reporter has read and answered all questions.

7. The system of claim 4, wherein information stored in the database information in comprises at least two of technical information, engineering information, scientific information, periodic financial information, trailing the activity information, tax specialty information, and reports generated by the report generator.

8. The system of claim 1, wherein the tax credit calculator interprets at least some of the database information to generate the tax credit.

9. The system of claim 1 further comprising a learning unit which modifies the question sets based at least in part on the information stored in the documentation database.

10. The system of claim 1, wherein the tax credit is a research tax credit.

11. The system of claim 7, further comprising a remote IRS reviewing unit which allows the IRS to review the tax credit report and the documents database to determine the accuracy of the generated tax credit without a visit by the IRS to the client site.

12. A method of establishing a research tax credit amount comprising:
choosing at least two reporters, the reporters being people working in a target business;
choosing at least one periodic reporting period;
choosing at least one question set for each reporter;
for each periodic reporting period:
receiving an answered question set from each reporter;
receiving at least one event not associated with the question set from at least one reporter;
modifying the question set based on the answered questions; and
generating a report for the IRS from information associated with the answered question wherein information associated with the at least one event not associated with the question set is listed separately.

13. The method of claim 12, wherein if at least one question set further comprises questions about whether a qualifying activity has occurred and wherein if answers received indicate that a qualifying event has occurred, then requiring the reporter associated with the question set to input documentation about the qualifying event.

14. The method of claim 13, wherein if answers received indicate that a qualifying event has occurred, then requiring at least one reporter not associated with the question set to input documentation about the qualifying event.

15. The method of claim 14, wherein the documentation comprises at least one of an email, a spreadsheet file, an instant message, a quote, a bid, personnel time information, personnel salary information; a letter; a proposal, a receipt, or a bill.

16. The method of claim 14, wherein if the documentation is not input within a specified time, an alert is set.

17. The method of claim 14, wherein the question set is modified to include questions about the qualifying event creating a modified question set.

18. The method of claim 14, wherein the modified question set includes questions about whether the qualifying event is still active.

19. The method of claim 12, wherein each reporter has a reporting area and wherein the reporter's question set is tailored to the reporter's reporting area.

20. The method of claim 12, whereby the business pays a contingency fee to report the tax credit at at least one site.

21. An apparatus for establishing a research tax credit for a business comprising:
means for choosing at least two reporters, the reporters working in the business;
means for choosing at least one reporting period;
means for choosing at least one question set for each reporter;
means for presenting each question set to each reporter;
for each reporting period:
means for receiving an answered question set from each reporter;
means for receiving information about at least one event not associated with the question set from at least one reporter;
means for modifying the at least one question set for each reporter based on the answered question set; and
means for generating a report for the IRS from the answered question set and from answers received from the modified question set wherein information associated with the at least one event not associated with the question set is listed separately.
